(19) United States
(12) Patent Application Publication
(10) Pub. No.: US 2006/0120553 A1
(43) Pub. Date: Jun. 8, 2006

(54) Speaker device

(76) Inventor: Kiyoshi Saito, Yamagata (JP)

Correspondence Address: YOUNG & THOMPSON, 745 SOUTH 23RD STREET, 2ND FLOOR, ARLINGTON, VA, 22202, US

(21) Appl. No.: 11/001,315

(22) Filed: Dec. 2, 2004

(30) Foreign Application Priority Data
Dec. 2, 2004 (JP) 2003-402426

(51) Int. Cl. H04R 9/06; H04R 11/02; H04R 1/00

(52) U.S. Cl. 381/398; 381/396

(57) ABSTRACT

The speaker device includes a connecting member for electrically connecting the voice coil and the external printed circuit board or the like. The connecting member includes a conductive member and a support member having elasticity and insulating property and supporting the conductive member in a state in which the conductive member is raised. An opening is formed in a frame, and one end portion of the connecting member is stably fixed to the frame in the opening. One end surface of the connecting member is electrically connected at a front sound emitting surface side of the frame, via solder. The other end portion is protruded to a rear surface side of the frame, which is an opposite side with respect to the sound emitting side, and the other end surface is electrically connected to a connecting portion such as a contact point of the printed circuit board.

### BACKGROUND OF THE INVENTION

1. Field of the Invention

The present invention relates to a speaker device which is loaded on an information apparatus such as a cellular phone.

2. Description of Related Art

As reduction in size and cost of information apparatuses such as cellular phones and PDAs (Personal Digital Assistants) has advanced in recent years, reduction in cost is required for the speaker devices which are the constituents of the information apparatuses. In such a speaker device, for example, as a method of electrically connecting a voice coil and a printed circuit board which is a constituent of an information apparatus, there are known a method by a connector terminal, a method of performing soldering to a flexible printed board, a method of using a coil spring, a plate spring or the like as a conductive member.

An electrical signal outputted from an information apparatus is supplied to a voice coil through such electrical connection, whereby a diaphragm vibrates in an axial direction of a speaker device, and sound reproduction is performed by the speaker device.

A contact mechanism of an electro-acoustic converter for electrically connecting a printed wiring board and an electro-acoustic converter via a coil spring is disclosed in a Japanese patent application Laid-open under No. 9-219740.

Also, there is known a loud speaker or the like which includes conductive plates in a spring form deformable at two electric contact points and at least one inhibition portion disposed near the plates for limiting the deformation of the plates is known (for example, see a Japanese patent application Laid-Open under No. No. 10-294982. According to this document, during manufacture of the loud speaker or the like, or when the loud speaker accidentally drops, the electric contact points are prevented from being broken by at least the one inhibition portion.

However, when the method of using a connecter terminal and the method of soldering to a flexible printed board are used, the component cost is high, or it is necessary to solder the member to the printed circuit board, thus increasing the cost.

When a coil spring terminal or a plate spring terminal is used as the conductive member, the conductive member is mounted to a frame in the state in which the conductive member is exposed. Therefore, when the conductive member drops during manufacture of the speaker device, deformation or the like occurs to the contact point region of the conductive member, and the contact point position of the conductive member is displaced by the deformation. Thereby, there arises the problem that a voice coil and a printed circuit board cannot be electrically connected with high reliability.

### SUMMARY OF THE INVENTION

As the problems to be solved by the present invention, those described above are cited as examples. The present invention has its object to provide a speaker device capable of electrically connecting a terminal of a speaker and an external board at low cost with high reliability.

According to one aspect of the present invention, there is provided a speaker device including a connecting member electrically connected to a voice coil and to be electrically connected to a connecting portion of an external circuit board, and the connecting member includes a conductive member, and a support member having elasticity and insulating property and supporting the conductive member.

The above-described speaker device is installed in an information apparatus such as, for example, a cellular phone, and is electrically connected to a circuit board in the information apparatus. The speaker device includes the connecting member connected to the voice coil. The connecting member includes a conductive member having electrical conductivity, and the support member having elasticity and insulating property and supporting the conductive member. The support member can be an elastic body or the like having, for example, insulating property. By supporting the conductive member by the support member, the connecting member has rigidity to some degree and enables stable electrical connection to a connecting portion of an external circuit. The connecting member has a simple construction in which the conductive member is supported by the support member, and therefore connection at low cost with high reliability is enabled as compared with the case in which the speaker device and the external board are connected by the connecting method accompanied by the connector and soldering.

In one mode, the speaker device may include a frame, and the connecting member may be fixed to the frame in a state in which the conductive member is supported by the support member in a raised state. The connecting member is fixed to the frame in the raised state, and therefore the connecting member is held between the frame and the external circuit board to be able to obtain electrical connection.

In a preferred example, the connecting member may be fixed to the frame in a state in which the connecting member is protruded to an opposite side of a sound emitting side of the aforesaid speaker device. Instead of this, the connecting member may be fixed to the frame in the state in which the connecting member is protruded to the sound emitting side of the speaker device. Which construction is adopted can be decided in accordance with the internal structure of the information apparatus or the like on which the speaker device is loaded.

In another mode, the conductive member may be in an approximately rectangular parallelepiped shape, and the support member may be disposed at a position where the support member covers at least one side surface of the conductive member, or at a position where the support members hold the conductive member from both side surfaces. In still another mode, the conductive member may be formed into an approximately circular cylinder shape, and the support member may be disposed at a position where the support member surrounds the conductive member from an entire circumferential direction. In this manner, the conductive member can be supported by the support member.

In a preferred embodiment, the conductive member may be either a metal wire with surface treatment by gold plating being applied, or a member in which plural gold particles or silver particles are mixed in a resin, and the support member may be made a member having insulation properties. The support member may be made of silicon solid rubber, sponge silicon rubber or the like.

The nature, utility, and further features of this invention will be more clearly apparent from the following detailed description with respect to preferred embodiment of the invention when read in conjunction with the accompanying drawings briefly described below.

### BRIEF DESCRIPTION OF THE DRAWINGS

FIGS. 1(A), 1(B) and 1(C) are a plan view and sectional views of a speaker device according to a first embodiment of the present invention;

FIGS. 2(A), 2(B), 2(C) and 2(D) are perspective views of a connecting member and variation examples of the connecting member, which are applied to the present invention; and

FIGS. 3(A), 3(B) and 3(C) are a plan view and sectional views of a speaker device according to a second embodiment of the present invention.

### DETAILED DESCRIPTION OF THE PREFERRED EMBODIMENTS

Hereinafter, preferred embodiments of the present invention will be explained with reference to the drawings. The embodiments provide speaker devices each capable of electrically connecting a voice coil of the speaker device and a printed circuit board of an information apparatus or the like at low cost with high reliability.

### First Embodiment

A first embodiment electrically connects the voice coil and the printed circuit board by a connecting member by making the connecting member protruded to a rear surface of a frame at an opposite side of a sound emitting side of the speaker device.

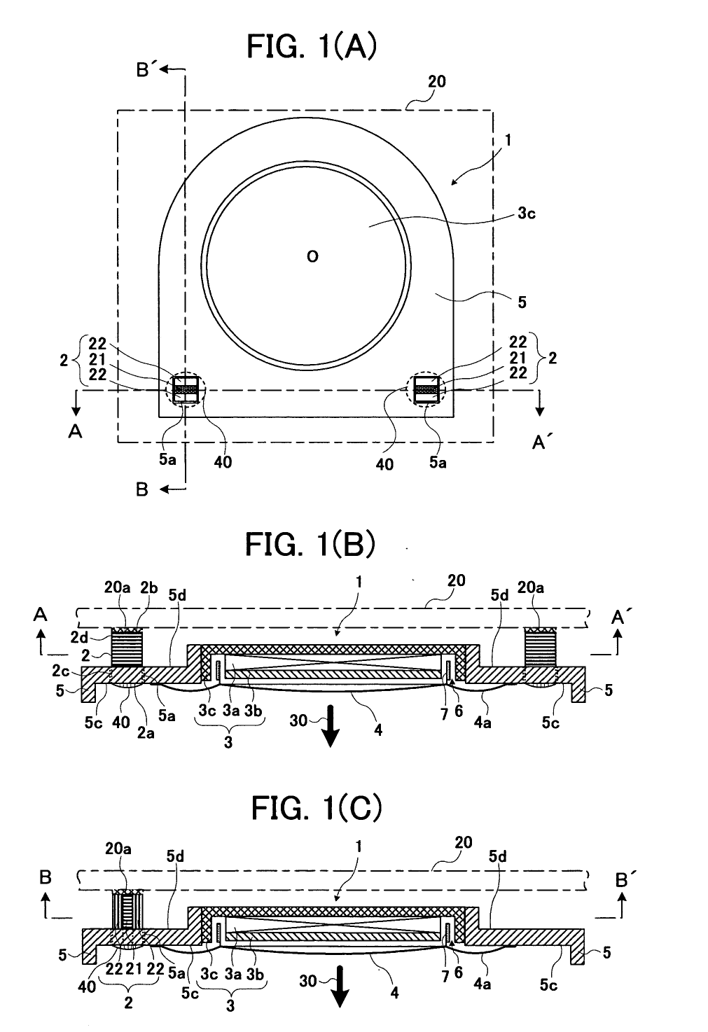

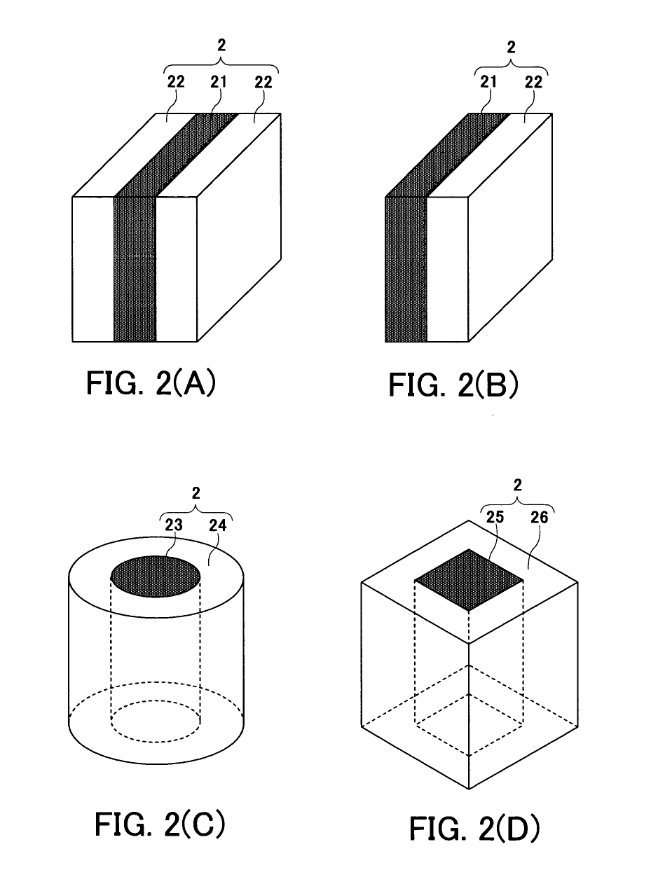

FIGS. 1(A), 1(B) and 1(C) schematically show a rough construction of a speaker device 1 according to the first embodiment of the present invention. FIGS. 2(A), 2(B), 2(C) and 2(D) show various kinds of examples of a connecting member 2 which is a constituent of the speaker device 1. FIG. 1(A) shows a plan view of a state in which the speaker device 1 and a connecting portion 20aof a printed circuit board 20 are electrically connected by the connecting member 2. FIG. 1(B) shows a sectional view taken along the cutting-plane line A-A′ of the speaker device 1 shown in FIG. 1(A). FIG. 1(C) shows a sectional view taken along the cutting-plane line B-B′ of the speaker device 1 shown in FIG. 1(A). FIG. 2(A) is a perspective view schematically showing a construction of the connecting member 2 applied to the speaker device 1 of the present invention. FIGS. 2(B) to 2(D) are perspective views showing variation examples of the connecting member 2 applicable to the speaker device 1. Hereinafter, the construction of the speaker device 1 according to the first embodiment of the present invention will be explained with reference to FIGS. 1(A), 1(B) and 1(C) and FIGS. 2(A), 2(B), 2(C) and 2(D).

The speaker device 1 includes the connecting member 2, a magnetic circuit portion 3, a diaphragm 4 and a frame 5 which supports the magnetic circuit portion 3 and the diaphragm 4. A voice coil 7 of the speaker device 1 is electrically connected to a connecting portion 20asuch as a terminal or the like on a printed circuit board 20 of an information apparatus via the connecting member 2 by using a method described later.

The connecting member 2 includes one conductive member 21, and two support members 22 as shown in FIGS. 1(A), 1(B) and 1(C) and FIG. 2(A). The conductive member 21 and the support member 22 are both formed into approximately rectangular parallelepiped shapes, and are in approximately the same size and shape. The conductive member 21 and the support members 22 are fixed to one another by, for example, an adhesive, and integrated. One end surface 2a and the other end surface 2b of the connecting member 2 have flatness.

The conductive member 21 is a conductive member which electrically connects the voice coil 7 of the speaker device 1 and the connecting portion 20a such as a contact point of the printed circuit board 20, and is not so high in rigidity due to its properties. For example, as the conductive member 21, a metal wire with surface treatment being applied by gold plating, a member made by mixing plural gold particles or silver particles in a resin, or the like is preferable.

As the support member 22, for example, an elastic body having insulation properties of, for example, silicon solid rubber, sponge silicon rubber or the like is preferable. The support members 22 have such rigidity as to make the conductive member 21 upright, and support the conductive member 21 in the upright state. The respective support members 22 are disposed at the position at which they hold the conductive member 21 between them. Therefore, the respective support members 22 support the conductive member 21 which is not so high in rigidity in a state in which the conductive member 21 is upright, and the connecting member 2 itself has elasticity to some degree. Since the connecting member 2 has elasticity to some degree, stable electrical connection can be kept between the connecting member 2 and the connecting portion 20a of the printed circuit board 20.

One end portion 2c of the connecting member 2 is held by the frame 5 in an opening 5a formed in the frame 5. Thereby, the connecting member 2 is fixed to the frame 5 in a stable state. One end surface 2a of the connecting member 2 is electrically connected to a lead wire (not shown) of the voice coil 7 which will be described later by solder 40 at a position of the opening 5a at the side of a front surface 5c of the frame 5 which is a sound emitting side.

Meanwhile, the other end portion 2d of the connecting member 2 protrudes to a rear surface 5d of the frame 5, which is at the opposite side from the sound emitting side. The other end surface 2b of the connecting member 2 is electrically connected to the connecting portion 20a of the printed circuit board 20, which has flatness.

The electrical connection of the other end surface 2b of the connecting member 2 to the connecting portion 20a is performed as follows, for example. First, the speaker device 1, and the printed circuit board 20 are respectively mounted to predetermined positions inside an information apparatus not shown, and thereafter, a pair of cases (not shown), which are constituents of the information apparatus, are fitted to each other. Thereby, the other end surface 2b of the connecting member 2 is electrically connected to the connecting portion 20a of the printed circuit board 20 in the state in which a constant pressure is applied. The conductive member 21 stably contacts the connecting portion 20a of the printed circuit board 20 by elasticity of the support members 22 which construct the connecting member 2, and thereby electrical connection can be kept.

The magnetic circuit portion 3 is constructed as an internal magnet type magnetic circuit, and has an annular magnet 3a, an annular plate 3b disposed to be overlaid on a lower part of the magnet 3a, and a yoke 3c which houses them. Application of the present invention is not limited to the internal magnet type speaker, and it can be also applied to various kinds of speakers such as an external magnet type speaker, for example.

The magnetic circuit portion 3 constructs a magnetic circuit by the magnet 3a and a plate 3b, and concentrates magnetic flux of the magnet 3a into a magnetic gap 6 provided between an outer peripheral surface of the plate 3b and an inner peripheral surface of the yoke 3c.

The diaphragm 4 is formed as a semispherical dome-shaped diaphragm, and the voice coil 7 is mounted to a base end side of the diaphragm 4. The voice coil 7 is disposed inside the magnetic gap 6 of the magnetic circuit portion 3. The lead wire not shown of this voice coil 7 is electrically connected by solder 40 to the one end surface 2a of the connecting member 2 at the position of the opening 5a at the side of the front surface 5c of the frame 5 as described above. An edge portion 4a of the diaphragm 4 is supported by the frame 5.

When an electrical signal is inputted into the conductive member 21 that is the constituent of the connecting member 2 through the connecting portion 20a of the printed circuit board 20 in the speaker device 1 described above, the electrical signal is supplied to the voice coil 7 via the lead wire (not shown) of the voice coil 7. Thereby, a driving force occurs to the voice coil 7 in the magnetic gap 6 to vibrate the diaphragm 4 in the axial direction of the speaker device 1. In this manner, the speaker device 1 generates sound in the direction of the arrows 30 in FIGS. 1(B) and 1(C).

As described above, the speaker device 1 of the present invention does not use a comparatively expensive connecting member such as a connector terminal as in the conventional speaker device, and therefore the production cost of the speaker device 1 can be reduced.

In the conventional speaker device with these expensive connecting members as constituents, it is necessary to perform soldering to connect the connecting members and the external circuit electrically. On the other hand, in the present invention, a pair of cases which are the constituents of the information apparatus are fitted to each other as described above, whereby the connecting member 2 and the connecting portion 20a of the printed circuit board 20 are electrically connected without soldering, and therefore a soldering operation is not needed, and the cost can be reduced correspondingly.

As a result, when the speaker device 1 and the printed circuit board 20 need to be repaired after the speaker device 1 and the printed circuit board 20 are mounted inside the information apparatus, the speaker device 1 and the printed circuit board 20 can be easily separated. Therefore, a repairing operation of the products to be repaired can be performed quickly and easily.

Further, in the above-described speaker device 1, the conductive member 21 is supported by the support member 22 having elasticity, and therefore, even when the connecting member 2 is dropped during manufacture of the speaker device 1, namely, while the connecting member 2 is mounted to the frame 5, deformation or the like does not occur to the connecting member 2, especially, the conductive member 21, because the connecting member 2, especially, the conductive member 21 is protected by elasticity of the support members 22. Therefore, even when the dropped connecting member 2 is mounted to the frame 5, the voice coil 7 and the connecting portion 20a can be electrically connected with high reliability.

In the above-described speaker device 1, the connecting member 2 of the construction shown in FIG. 2(A) is applied, but the connecting member 2 is not limited to this.

Namely, if the connecting member has the construction in which the support member can support the conductive member which is not so high in rigidity in the upright or raised state, connecting members of various kinds can be applied to the speaker device 1. For example, as such a connecting member 2, the connecting members 2 shown in FIGS. 2(B) to 2(D) can be applied to the speaker device 1.

The connecting member 2 shown in FIG. 2(B) includes one conductive member 21 in an approximately rectangular parallelepiped shape, and one support member 22, and the side surfaces facing to each other of them are adhered to each other. The connecting member 2 shown in FIG. 2(C) includes a conductive member 23 in an approximately circular cylinder shape, and a cylindrical support member 24, and an outer surface of the conductive member 23 and an inner surface of a support member 24 are adhered to each other. The connecting member 2 shown in FIG. 2(D) includes a conductive member 25 in an approximately rectangular parallelepiped shape, and a support member 26 in an approximately rectangular parallelepiped shape having a space in a rectangular parallelepiped shape in a center, and an outer surface of the conductive member 25 and an inner surface of the support member 26 are adhered to each other. In the connecting members 2 shown in the above FIGS. 2(B) to 2(D), the support members 22, 24 and 26 support the conductive members 21, 23 and 25 in the upright or raised state, respectively, and gives the elasticity of certain degree to the connecting member 2. In the examples of these connecting members, the conductive members and the support members can be adhered to each other by, for example, an adhesive or the like.

### Second Embodiment

In a second embodiment, a connecting member is protruded to a front surface of a frame, which is a sound emitting side of a speaker device, and a voice coil and a connecting portion of a printed circuit board are electrically connected by the connecting member.

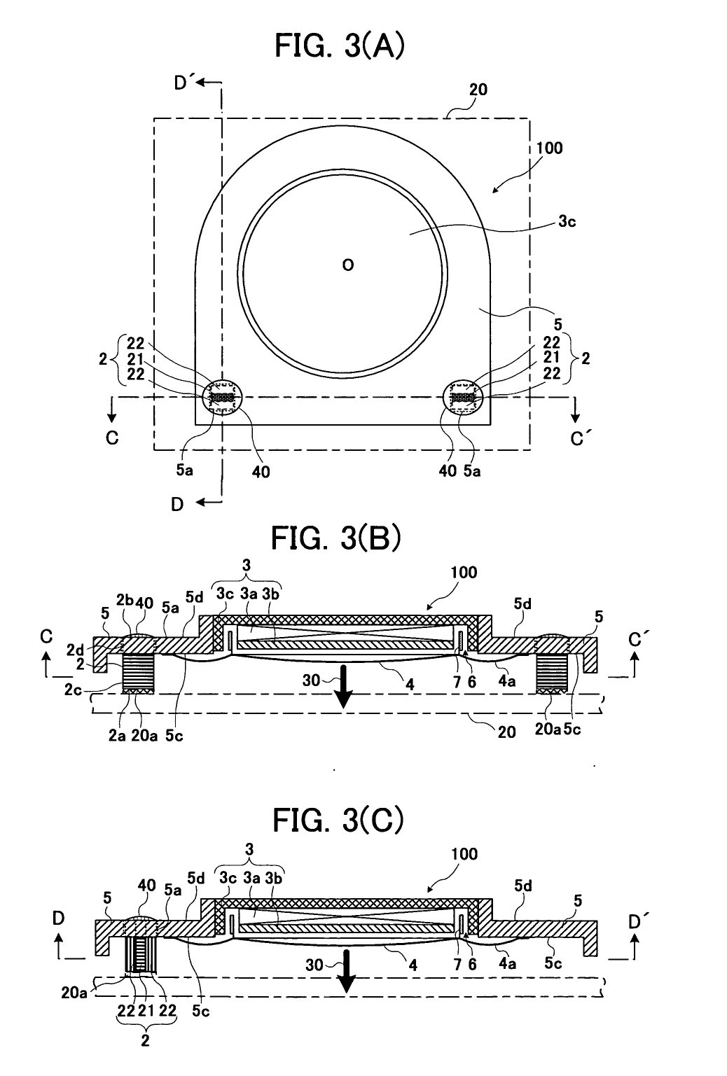

FIGS. 3(A), 3(B) and 3(C) show schematic construction diagrams of a speaker device 100 according to the second embodiment of the present invention. FIG. 3(A) shows a plan view of a state in which the speaker device 100 and a connecting portion 20a of a printed circuit board 20 are electrically connected by a connecting member 2. FIG. 3(B) shows a sectional view taken along the cutting-plane line C-C′ of the speaker device 100 in FIG. 3(A). FIG. 3(C) shows a sectional view taken along the cutting-plane line D-D′ of the speaker device 100 in FIG. 3(A). A construction of the speaker device 100 and the like will be explained with priority given to the point differing from the speaker device 1 in the first embodiment, with reference to FIGS. 3(A), 3(B) and 3(C). In the speaker device 100, the same constituents as in the speaker device 1 of the first embodiment are given the same reference numerals and characters.

The speaker device 100 performs electrical connection of a voice coil and a printed circuit board by a connecting member 2 as in the speaker device 1 of the first embodiment. However, comparing the speaker device 1 of the first embodiment and the speaker device 100 of the second embodiment, they differ from each other in the following point. Namely, in the speaker device 1 of the first embodiment, the connecting member 2 is protruded to the rear surface 5d of the frame, and is electrically connected to the connecting portion 20a of the printed circuit board 20 at the rear surface 5d side of the speaker device, namely, at the opposite side from the sound emitting side. On the other hand, in the speaker device 100 of the second embodiment, the connecting member 2 is protruded to the front surface 5c side of the frame, and is electrically connected to the connecting portion 20a of the printed circuit board 20 at the front surface 5c side of the speaker device, namely, the sound emitting side.

In the speaker device 100, the other end portion 2d of the connecting member 2 is held by the frame 5 in the opening 5a of the frame 5. Thereby, the connecting member 2 is fixed to the frame 5 in a stable state. The other end surface 2b of the connecting member 2 is electrically connected to the lead wire (not shown) of the voice coil 7 at the position of the opening 5a at the side of the rear surface 5d of the frame 5 at the opposite side from the sound emitting side via solder 40.

Meanwhile, one end portion 2c of the connecting member 2 is protruded to the front surface 5c of the frame 5. The one end surface 2a of the connecting member 2 is electrically connected to the connecting portion 20a of the printed circuit board 20. A method for connecting the one end surface 2a of the connecting member 2 and the connecting portion 20a is the same as the method described in the first embodiment. Various kinds of connecting members 2 shown in the above-described FIG. 2(B) to 2(D) can be applied to the speaker device 100 as in the speaker device 1 of the first embodiment.

The above-described speaker device of the present invention provides the following effect in addition to the above-described effect. Namely, in the speaker device of the present invention, the opening 5a is formed in the frame 5. Therefore, the voice coil 7 and the connecting portion 20a of the printed circuit board 20 can be electrically connected in the state in which the connecting member 2 is protruded to either one of the front surface 5c of the frame 5 or the rear surface 5d of the frame 5 as necessary without making design change of the frame 5. Namely, when the connection to the printed circuit board 20 is made at the sound emitting side, and when it is made at the opposite side from the sound emitting side, the same frame 5 can be used. Therefore, the degree of freedom of the design of the speaker device can be enhanced.

The invention may be embodied on other specific forms without departing from the spirit or essential characteristics thereof. The present embodiments therefore to be considered in all respects as illustrative and not restrictive, the scope of the invention being indicated by the appended claims rather than by the foregoing description and all changes which come within the meaning an range of equivalency of the claims are therefore intended to embraced therein.

The entire disclosure of Japanese Patent Application No. 2003-402426 filed on Dec. 2, 2003 including the specification, claims, drawings and summary is incorporated herein by reference in its entirety.

What is claimed is:

1. A speaker device, comprising:
a connecting member electrically connected to a voice coil and to be electrically connected to a connecting portion of an external circuit board,
wherein said connecting member comprises a conductive member, and a support member having elasticity and insulating property and supporting the conductive member.

2. The speaker device according to claim 1, further comprising a frame,
wherein said connecting member is fixed to said frame in a state in which the conductive member is supported by the support member in an upright state.

3. The speaker device according to claim 1, wherein said connecting member is fixed to said frame in a state in which said connecting member is protruded to an opposite side of a sound emitting side of said speaker device.

4. The speaker device according to claim 1, wherein said connecting member is fixed to said frame in a state in which said connecting member is protruded to a sound emitting side of said speaker device.

5. The speaker device according to claim 1, wherein the conductive member is in an approximately rectangular parallelepiped shape, and the support member is disposed at a position where the support member covers at least one side surface of the conductive member.

6. The speaker device according claim 1, wherein the conductive member is in an approximately rectangular parallelepiped shape, and the support members are disposed at a position where the support members hold the conductive member from both side surfaces.

7. The speaker device according to claim 1, wherein the conductive member is in an approximately circular cylinder shape, and the support member is disposed at a position where the support member surrounds the conductive member from an entire circumferential direction.

8. The speaker device according to claim 1, wherein the conductive member is either a metal wire with surface treatment by metal plating being applied, or a member in which plural gold particles or silver particles are mixed in a resin;
wherein the support member is a member having insulation property; and
wherein the support member is of either silicon solid rubber or sponge silicon rubber.
